(19) United States
(12) Patent Application Publication
(10) Pub. No.: US 2014/0067112 A1
(43) Pub. Date: Mar. 6, 2014

(54) Coded bottle/container sealing device

(71) Applicant: Dennis Wayne Rice, Flanders, NJ (US)

(72) Inventor: Dennis Wayne Rice, Flanders, NJ (US)

(73) Assignee: Medco Health Solutions, Inc., Franklin Lakes, NJ (US)

(21) Appl. No.: 11/729,455

(22) Filed: Mar. 29, 2007

(51) Int. Cl. G06F 19/00

(52) U.S. Cl. CPC G06F 19/3456
USPC 700/235

(57) ABSTRACT

A coded sealing device for a medicine bottle includes a substantially solid structure comprising a first sidewall, a first top surface, and a first concavity. A label is located on at least one of the first sidewall and first top surface, and the first concavity is for receiving a medicine bottle. In at least one embodiment, at least one of the first sidewall, first top surface, and label may include a color coding and/or other indicia. The label containing information relevant to the patient may be located on at least one of the first sidewall and first top surface. The coded sealing device also includes various alternative embodiments.

### FIELD OF THE INVENTION

The present invention generally relates to a coded sealing device and/or coded bottle sealing device and/or coded container sealing device. The present invention also generally relates to methods for using a coded sealing device and/or coded bottle sealing device and/or coded container sealing device.

### BACKGROUND OF THE INVENTION

The present invention relates to the general field of pharmaceutical or medication bottles and/or containers. More specifically, the present invention relates to lessening user errors when identifying their medicine bottle and/or container. It can be a problem for families, couples, or even individuals to accidentally select the wrong medicine bottle and/or container and ingest the wrong medication. For example, in a family of four with many prescriptions (e.g., heart medication for a father, birth control for a mother, multiple allergy medications for children, etc.), a member of the family may accidentally confuse their prescription with another family member and ingest it. This mistake may lead to numerous deleterious results.

Problems related to the accidental misuse of prescriptions produce not only a physical burden on the party who ingested the substance, but also produce a heavy economic burden. For example, in 2000 the U.S. spent nearly $76 billion correcting complications related to medication errors including accidental misuse of prescriptions. Further, this expenditure greatly increases when secondary effects of medication errors are factored in. For example, secondary expenditures, such as, costs of injuries to third parties caused by an individual who accidentally misuses a prescription, costs of absenteeism from work, and costs related to allocating medical staff for such incidents can cause a heavy economic burden.

U.S. application 2003/0214129 (hereinafter “Adler”), which is hereby incorporated by reference in its entirety, describes a new shape for a prescription bottle with labels for those bottles. However, for some, the cost of reshaping medication bottles, the user's resistance to change, and the market's resistance to change appears to have found this solution unpractical.

U.S. Pat. No. 4,227,615 (hereinafter “Flick”), which is hereby incorporated by reference in its entirety, describes an opaque bottle at least partially for viewing the contents of the medicine bottle. Unfortunately, many users of prescription medication are not familiar with the markings on their prescriptions. Accordingly, numerous problems exist with the aforementioned solution.

The present invention addresses and applies a novel technology to the aforementioned problems.

### SUMMARY OF THE INVENTION

In accordance with the present invention, a coded bottle/container sealing device and methods for production are provided.

In some embodiments, a coded medication sealing device for a medication container, includes a substantially solid structure comprising a first sidewall, a first top surface, and a first concavity. The coded medication sealing device also includes a label located on at least one of the first sidewall and first top surface, and a first sealing structure comprising a concavity receiving section receiving and sealing the medication container.

In some embodiments, a color-coded sealing device includes a first color-coded top surface, a second color-coded sidewall surface, a concavity receiving section created by the first top surface and second sidewall surface. The color-coded sealing device also includes a label attached to at least one of the first color-coded top surface and second color-coded sidewall surface. The concavity receiving section is designed for receiving at least one of a medicine bottle and medicine container.

In some embodiments, a color-coded sealing device, includes a first top surface, a second sidewall surface, a concavity receiving section created by the first top surface and second sidewall surface. The coded sealing device also includes a color-coded label attached to at least one of the top surface and sidewall surface. The concavity is designed for receiving at least one of a medicine bottle and medicine container.

In some embodiments, a method for using a color-coded sealing device, includes: reading in relevant data pertaining to a user; assigning a coded sealing device based on relevant data pertaining to a user; and attaching the coded sealing device to a bottle filled with the user's prescription.

In some embodiments, a coded medication sealing device for a medication container for use by an individual, includes a substantially solid structure comprising a first sidewall, a first top surface, and a first concavity. Indicia is printed on the substantially solid structure and disposed on at least one of the first sidewall and first top surface. The indicia comprises information indicative of characteristics of the individual, including at least one of sex of the individual, whether the individual is one of an adult and child, and individual specific medication information. The coded medication sealing device also includes a first sealing structure comprising a concavity receiving section receiving for sealing the medication container.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments, different combinations of embodiments described herein, and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

Various objects, features, and advantages of the present invention can be more fully appreciated with reference to the following detailed description of the invention when considered in connection with the following drawings, in which like reference numerals identify like elements.

FIG. 1 illustratively displays a prior art medicine bottle.

FIG. 2 illustratively displays a medicine bottle including a coded medicine bottle/container sealing device with labeling on the sidewall of the sealing device in accordance with some embodiments of the disclosed subject matter.

FIGS. 3-4 illustratively display medicine bottle/container sealing devices with labeling on the sidewall of the medicine bottle sealing device in accordance with some embodiments of the disclosed subject matter.

FIG. 5 illustratively displays a medicine bottle/container including a coded medicine bottle/container sealing device with labeling on the top surface of the sealing device in accordance with some embodiments of the disclosed subject matter.

FIGS. 6-7 illustratively display medicine bottle/container sealing devices with labeling on the top surface of the medicine bottle/container sealing device in accordance with some embodiments of the disclosed subject matter.

FIG. 8 illustratively displays a method for filing a prescription using a coded medicine bottle/container sealing device in accordance with some embodiments of the disclosed subject matter.

### DETAILED DESCRIPTION OF THE INVENTION

The following description includes many specific details. The inclusion of such details is for the purpose of illustration only and should not be understood to limit the invention. Moreover, certain features which are well known in the art are not described in detail in order to avoid complication of the subject matter of the present invention. In addition, it will be understood that features in one embodiment may be combined with features in other embodiments of the invention.

Before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the invention be regarded as including equivalent constructions to those described herein insofar as they do not depart from the spirit and scope of the present invention.

For example, the specific sequence of the described process may be altered so that certain processes are conducted in parallel or independent, with other processes, to the extent that the processes are not dependent upon each other. Thus, the specific order of steps described herein is not to be considered implying a specific sequence of steps to perform the process. Other alterations or modifications of the above processes are also contemplated. For example, further insubstantial approximations of the process and/or algorithms are also considered within the scope of the processes described herein.

In addition, features illustrated or described as part of one embodiment can be used on other embodiments to yield a still further embodiment. Additionally, certain features may be interchanged with similar devices or features not mentioned yet which perform the same or similar functions. It is therefore intended that such modifications and variations are included within the totality of the present invention.

It will be apparent that the usage of the word medicine bottle refers to any medicine container deemed suitable. Further, it will be apparent, that in some embodiments the word medicine bottle refers to any container or bottle. It will be apparent that the usage of the word medicine refers to any form of medication. For example, the word medicine refers to a liquid medication, capsule, powder, pill, and tablet. It will also be apparent that the term sealing device refers to any reasonable and/or effective sealing device for a container or bottle. For example, a sealing device may refer to a lid, cap, a threaded closure, lightning-type closure, stoppers, non-threaded closure, or any other sealing device deemed suitable.

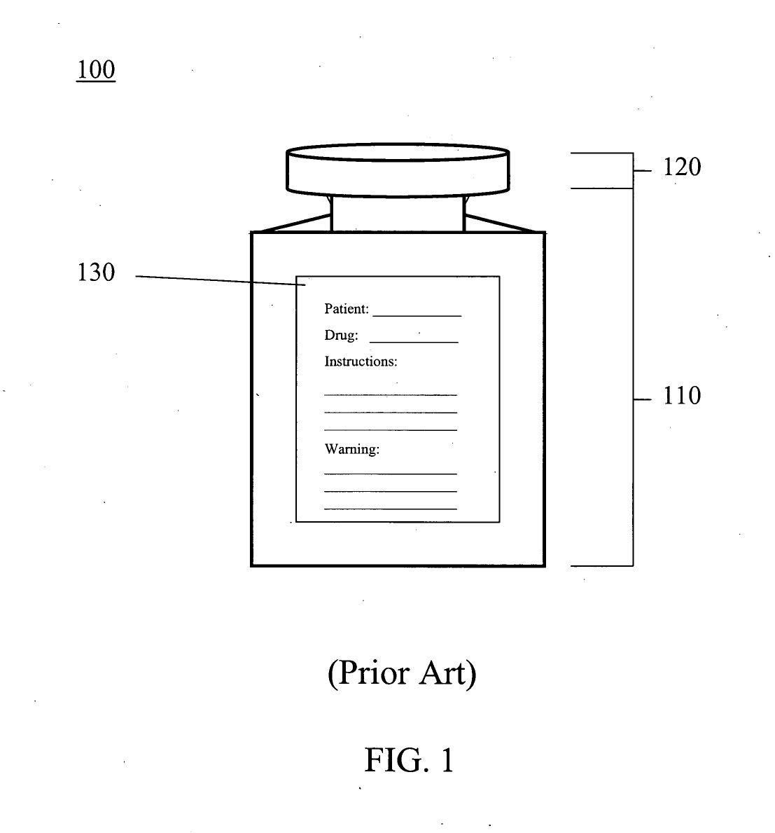

Referring to FIG. 1, an exemplary prior art medicine bottle is displayed. Medicine bottle 100, also known as a medication container, may include a first bottle 110 and a first sealing device 120. First bottle 110 may include a label 130 displaying information (e.g., indicia) related to the contents of the bottle, the user's information, and warnings associated with the prescription. For example, label 130 for a medicine bottle for a cough syrup containing Codeine may include the user's name (e.g., John Doe), the drug's name (e.g., Dextromethorphan and Codeine), and a warning (e.g., Warning: May Cause Drowsiness). In alternative embodiments, label 130 can include the same information displayed on the label of the medication bottle and/or any subset of that information. First bottle 110 may include any shape deemed suitable. For example, first bottle 110 may be round, square, square with rounded edges, or any other shape deemed suitable. First sealing device 120 can be any shape deemed suitable. For example, first sealing device 120 may be round with internal threads, square with internal threads, square with rounded edges, or any other shape deemed suitable. Further, first sealing device 120 may include a tamper resistant thread for inhibiting children from opening medicine bottle 100. It will be apparent that any shape that allows first bottle 110 and first sealing device 120 to mate (e.g., temporarily connect to one another) will be deemed suitable.

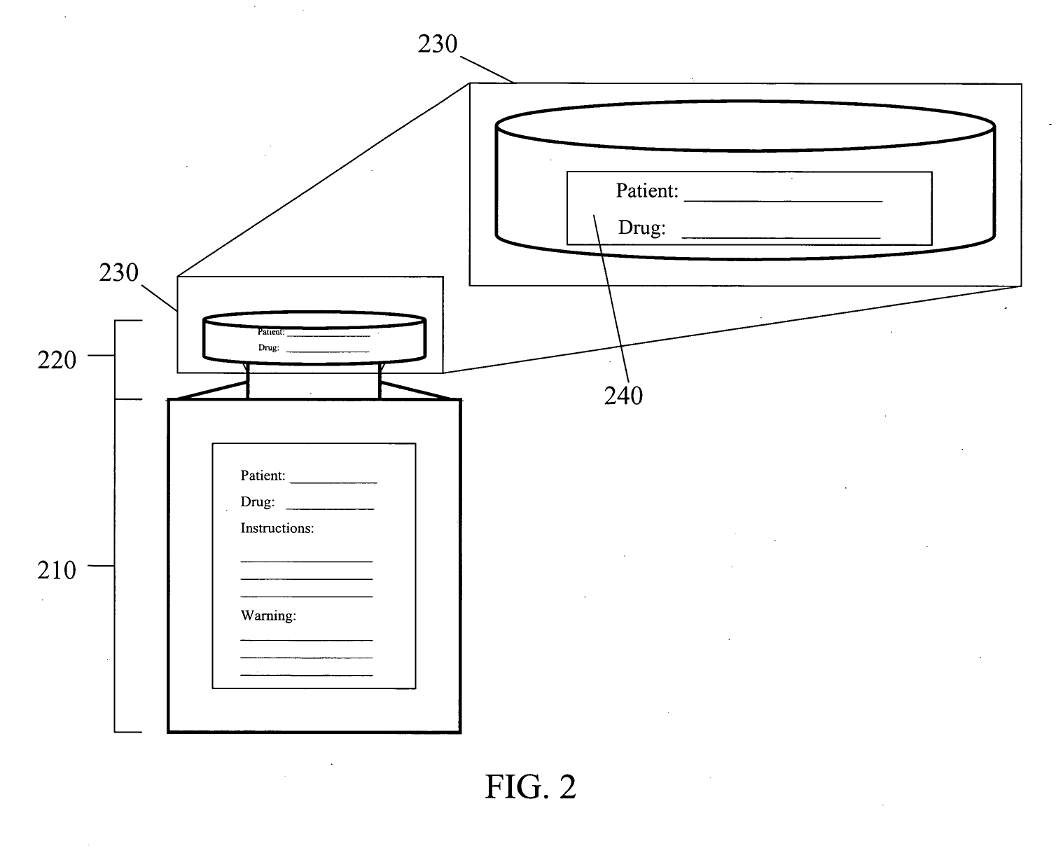

Referring to FIG. 2, a coded sealing device 220 in accordance with at least one of the embodiments of the present invention may include information relevant to the patient's prescription and/or similar or the same information displayed on the medication bottle. For example, coded sealing device 220 may include indicia relevant to the patient's prescription. Further, in some embodiments coded sealing device 220 may include a label including indicia printed on it including the user's name, the user's initials, or the drug's name. In some instances, a medicine bottle 210 may mate with coded sealing device 220. As shown in expanded region 230, in some embodiments, coded sealing device 220 may include information relevant to the patient (i.e., the user). In some embodiments, a label 240 may be located on coded sealing device 220. For example, in some embodiments label 240 may be located on at least one of the sidewall of coded sealing device 220, top surface of a coded sealing device 220, and any other surface of coded sealing device 220. For example, not shown, in some embodiments coded sealing device 220 may include an additional surface extending from coded sealing device 220 for including a label. For example, the top surface of coded sealing device 220 may include an extension (e.g., pyramidal shaped extension, triangular shaped extension, planar extension, rounded extension, etc.) for including a label. It will be apparent that coded sealing device 220 may include any first sealing device 120 (e.g., any standard medicine bottle sealing device) with at least one of a label providing information relevant to the patient's prescription, a color-coded label providing information relevant to the patient's prescription, and a colored coded sealing device.

In some embodiments, label 240 located on coded sealing device 220 may include a label that is printed and then attached to coded sealing device 220. For example, label 240 may be printed onto adhesive paper and attached to coded sealing device 220. In other embodiments, label 240 may be printed directly onto coded sealing device 220. For example, a printer may print directly onto coded sealing device 220. In other embodiments, label 240 may include a label that is printed on adhesive paper designed to fit within the boundaries of coded sealing device 220. For example, label 240 may be designed to fit on at least one of the top surface and sidewall surface of coded sealing device 220. Further, label 240 may be designed to not hang off of the edge of coded sealing device 220.

In some embodiments, coded sealing device 220 may include a plastic material. For example, coded sealing device 220 may include poly(vinyl chloride), polyethylene, poly(methyl methacrylate), acrylics, silicones, polyurethanes, thermoplastic, thermoset plastic, elastomers, engineering plastic, and any other material deemed suitable. In some embodiments, coded sealing device 220 can be substantially geometrically similar to a traditional medicine bottle sealing device. For example, coded sealing device 220 may include a top surface, a sidewall, and an internal concavity with a thread. It will be apparent that, in some embodiments, the internal concavity in sealing device 220 may be a concavity receiving section for receiving a bottle or container. Further, for example, in some embodiments, coded sealing device 220 may include a tamper resistant thread. In other embodiments, the geometry of a coded sealing device 220 may vary from a traditional medicine sealing device. For example, coded sealing device 220 may have a triangular shaped extension creating an additional flat surface to affix a label.

In some embodiments, label 240 may include information relevant to the patient. For example, in some embodiments, label 240 may include the patient's name and prescription. It will be apparent that this may be done for ease in recognizing ones prescription. In some embodiments, label 240 may include warnings to the patient. For example, label 240 may include a warning of common side effects. In some embodiments, label 240 may include at least one of the patient's name, the patient's last name, the patient's initials, a combination of the patient's name and initials, a symbol, the prescription, the generic drug name, a warning, information relevant to the drug's use, and the physician's name. It will be apparent that label 240 may include any relevant information. In some embodiments, label 240 may be located on any region of coded sealing device 220 deemed suitable. Further, it will be apparent that any information provided on a label may be provided as indicia printed on a label or on a medicine bottle. In some embodiments, for example, indicia may include information indicative of characteristics of the individual (e.g., sex of the individual, whether the individual is one of an adult and child, individual specific medication information, etc.).

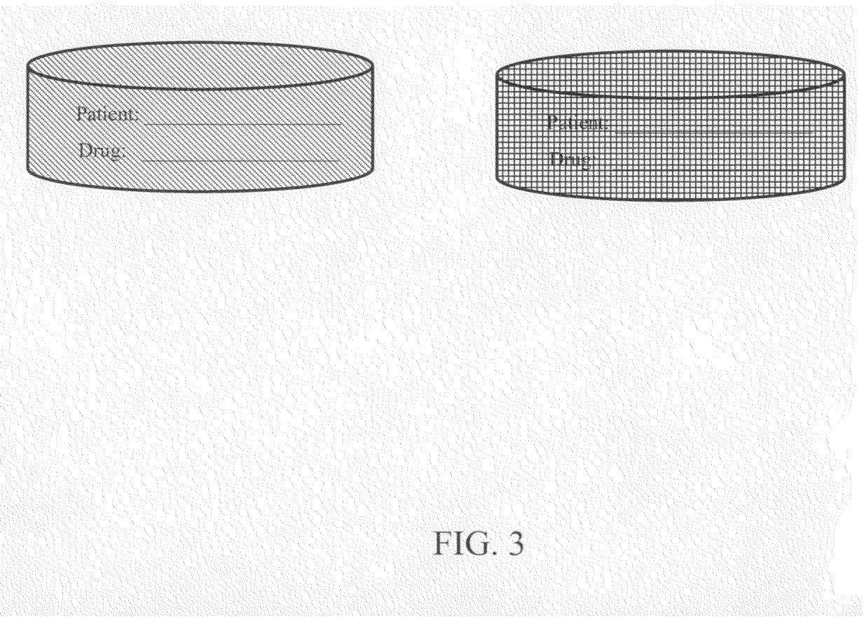

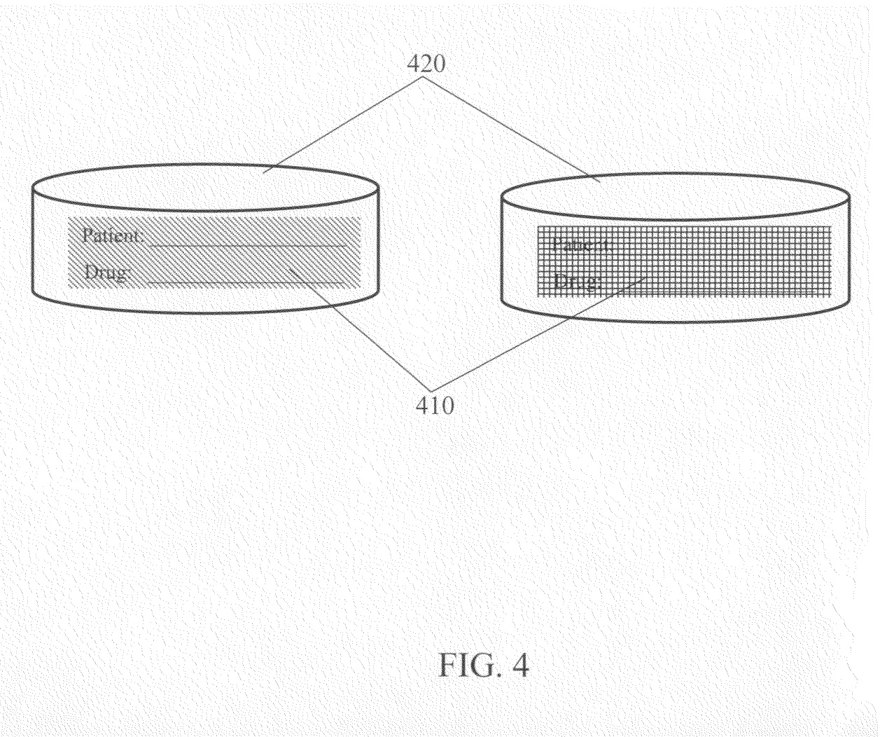

Referring to FIGS. 3-4, in some embodiments, coded sealing device 220 may include color-coding. For example, coded sealing device 220 may include a color that is specific to an individual user, groups of users, types of users, or any group or person deemed suitable. For example, Jon Doe may only receive blue coded sealing devices and Jane Doe may only receive pink coded sealing devices. In some embodiments, a user may have a color assigned to them by at least one of a pharmacy, the patient's doctor, the patient's request, or any other means deemed suitable for assigning a color to the user or group that user belongs to. In some embodiments, the color of coded sealing device 220 may be based on, for example, sex, gender, relationship in a family, or any other means deemed suitable. For example, in some embodiments a coded sealing device 220 given to a male may be blue and a second coded sealing device 220 given to a female may be pink. In some embodiments, a child may receive one color-coded sealing device while a parent may receive another color-coded sealing device. For example, a son may receive a blue coded sealing device, a daughter may receive a pink coded sealing device, a father may receive a red coded sealing device, and a mother may receive an orange coded sealing device. It will be apparent that any color combination may be used. In some embodiments, the sealing device may include a pattern rather than a color. For example, a striped pattern may be located on one coded sealing device and a checkered pattern may located on another coded sealing device. This may be done, for example, for colorblind users. In some embodiments, the shape of the sealing device may be coded. For example, geometric variations (e.g., dimples) may be located on the surface of a coded sealing device for helping a blind individual identify their medication.

In some embodiments, a label may be located on the coded sealing device. For example, as shown in FIG. 3, a label may be located on the outer region of the coded sealing device. It will be apparent that this may be done for ease in differentiating medicine bottles. In some embodiments, the coded sealing device may have a designated color while the label may not have a designated color. In other embodiments, both the coded sealing device and the label may have a designated color. In some embodiments, a label may be designed to fit on at least one of the sidewall and top surface of the coded sealing device. In some embodiments, a label may be located on a sealing device (e.g., a coded sealing device, a standard sealing device, etc.). In some embodiments, a label located on a sealing device may include information relevant to the user's sex (e.g., male or female) or parent/child relationship.

Referring to FIG. 4, in some embodiments, a coded sealing device may include a color-coded label attached to the coded sealing device. In some embodiments, a color-coded label may be located on the sidewall surface of a coded sealing device. It will be apparent that any color combination, pattern combination, or shape of color-coded label 410 may be placed on coded sealing device 420 for ease in identifying ones medication. In some embodiments, a color-coded label may be designed to fit on at least one of the sidewall and top surface of the coded sealing device. In some embodiments, coded sealing device 420 may not be color-coded and only color-coded label 410 may include a color for easing identifying ones medication.

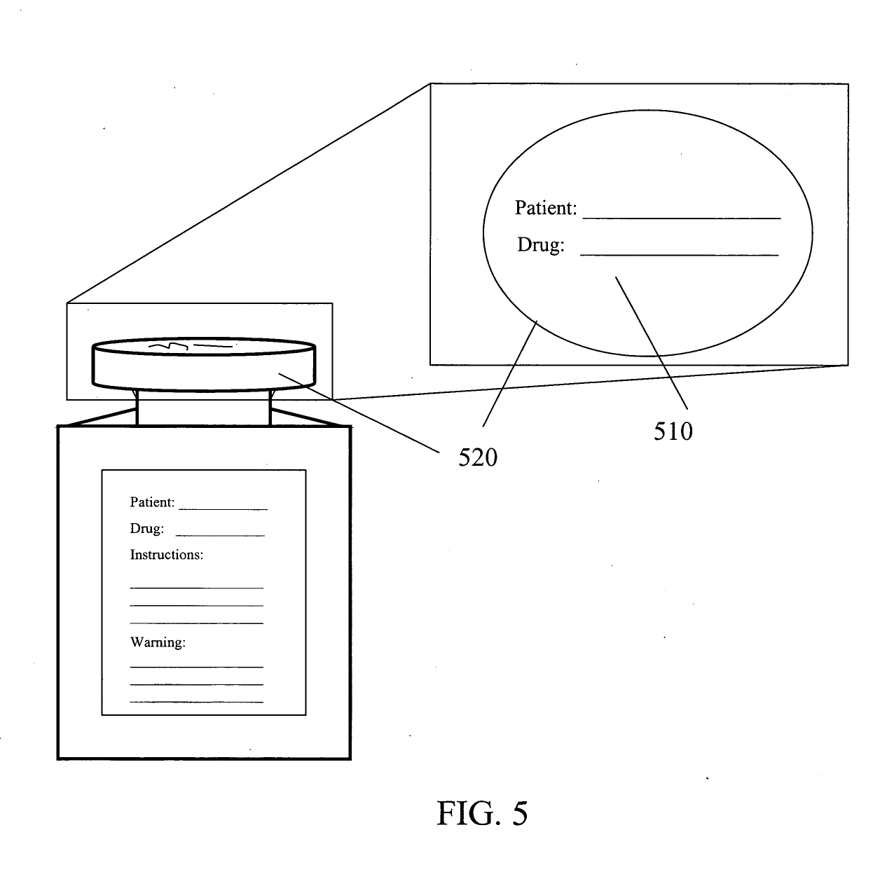

Referring to FIG. 5, in some embodiments a label may be located on the top surface of a coded sealing device. For example, a label 510 displaying patient information (e.g., patient name, drug, etc.) may be located on the top of coded sealing device 520. This may be done, for example, to ease in differentiating ones medicines. Although not shown, in some embodiments, a surface may extend from the top surface of a coded sealing device and a label may be attached to it.

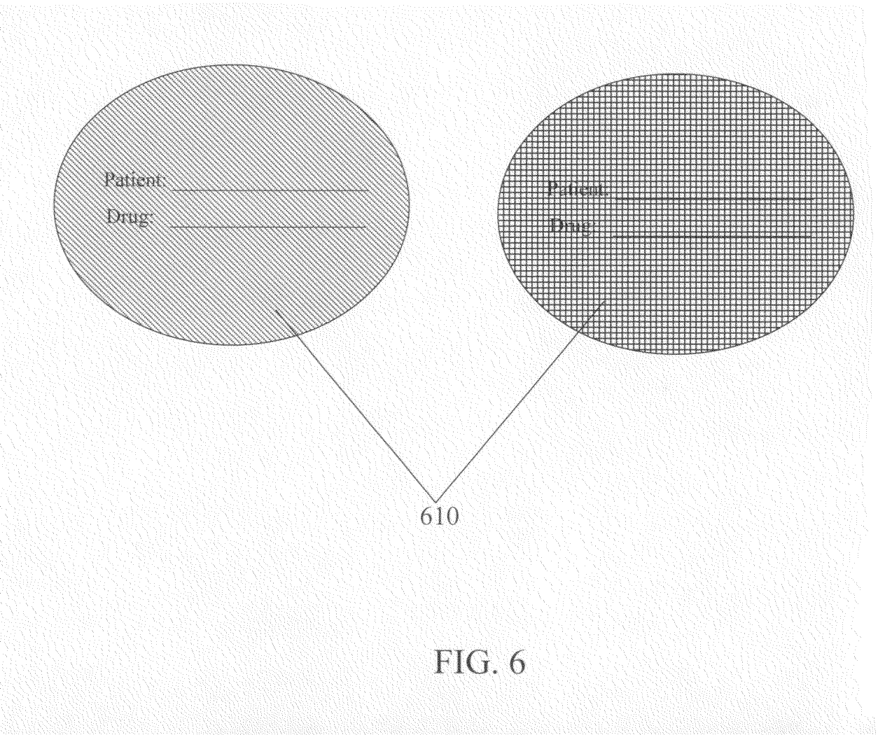

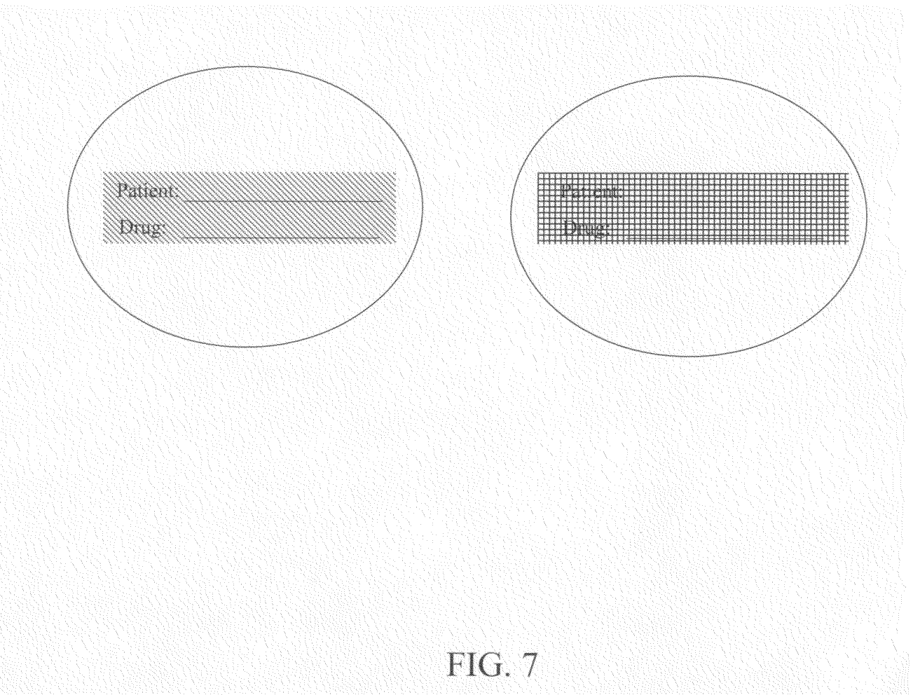

Referring to FIGS. 6-7, in some embodiments, a coded sealing device with a label on top may include color-coding. That is, coded sealing device 610 may include a color-coding and a label may be attached to the color-coded sealing device. It will be apparent that a label located on the top surface of a coded sealing device may exhibit substantially similar properties to a label located on the sidewall of a coded sealing device. For example, information that may be provided on a label located on the sidewall of a coded sealing device may also be provided on a label located on the top surface of a coded sealing device.

Referring to FIG. 7, in some embodiments, a color-coded label may be located on the top surface of a coded sealing device. For example, any color, pattern, depression, protrusion and/or shape may be used for a color-coded label and that label may be attached to a coded sealing device. Further, in some embodiments, the coded sealing device may be a standard sealing device with a color-coded label attached to it on any surface. It will be apparent that any color, pattern, or shape described for a label located on the sidewall of a coded sealing device may be used for a label on the top surface of a coded sealing device.

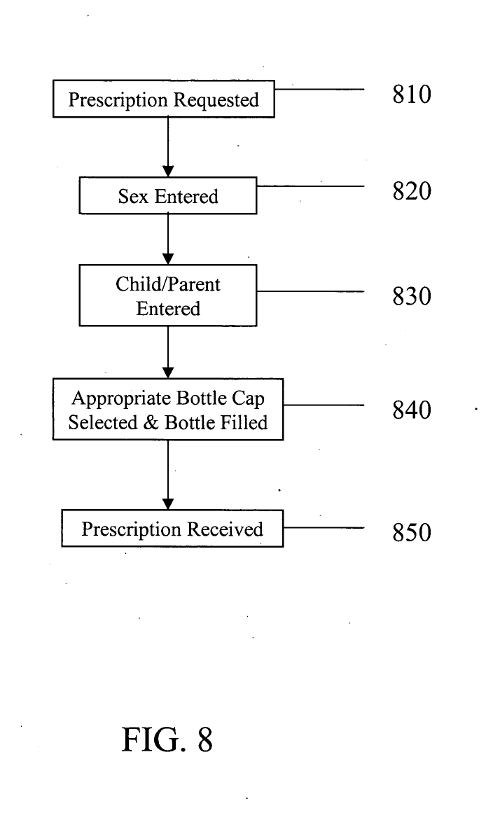

Referring to FIG. 8, in some embodiments, the user's coded sealing device may be selected based on information about that user. For example, a prescription may be requested, 810, the user's sex may be entered, 820, any secondary relationships such as, for example, the users child/parent status may be entered, 830, the appropriate coded-sealing device may be selected, 840, and the user's prescription may be received in a medicine bottle with a coded sealing device, 850. It will be apparent that information from steps 820 and 830 may be stored in a database and received by a pharmacist. Further, it will be apparent that any other relevant information may be used for selecting the appropriate coded sealing device. It will be understood that any of the aforementioned steps may be further separated, combined, removed, or added to.

In some embodiments, the medicine bottle and the sealing device may be coded. In other embodiments only the medicine bottle or the sealing device may be coded. In some embodiments, a coded medicine bottle may be color-coded based on a user or group of users. For example, in some embodiments, the medicine bottle may be color-coded based on at least one of the sex (e.g., male or female) and the family status (e.g., child or parent) of the user. In some embodiments, a color-coded medicine bottle may be designed to mate with a coded sealing device. For example, a blue color-coded medicine bottle (e.g., for a boy) may mate with a blue coded sealing device and a pink color-coded medicine bottle (e.g., for a girl) may mate with a pink coded sealing device. It will be apparent that any color combination may be used to designate any relationship (e.g., male/female, parent/child, partner/partner, grandparent/parent, etc.). In some embodiments, the coded bottle may include a coded label. For example, the label on the medicine bottle may be color-coded. For example, a blue label may be located on a medicine bottle for a boy.

In some embodiments, a medicine bottle may exhibit a specific geometry based on a user or group of users. For example, a medicine bottle may exhibit a specific geometry based on at least one of the user's sex (e.g., male or female) and family relationship (e.g., parent, child, grandparent, etc.). In some embodiments, the coded medicine bottle may include a bulbous shape indicative of the user's sex. For example, a male bottle may be wider at the top and narrower at the bottom while a female coded bottle may be wider in the middle and narrower at the top and bottom. It will be apparent that any geometric variation may be used to distinguish between a user or group of users. In some embodiments, the coded medicine bottle may be designed to correspond with a coded sealing device.

In some embodiments, at least one of a coded bottle and coded sealing device may include an additional material or a geometric variation indicative of the user or user's group. For example, a coded sealing device may include a skirt or pants extending from the coded sealing device. It will be apparent that this additional material or geometric configuration may be indicative of the user or user's group. For example, a male user may have pants extending from his coded medicine bottle while a female user may have a skirt extending from her coded medicine bottle. It will be apparent that any geometric configuration or material extending from the coded sealing device or coded bottle can be used to distinguish the user.

In some embodiments, geometric variations may be located on the medicine bottle. For example, in some instances a medicine bottle may include small deviations in the surface of the bottle (e.g., dimples, nubs, grooves, etc.). It will be apparent that geometric variations in the medicine bottle may produce a coded medicine bottle that may assist those who are visually impaired (e.g., color blind, blind, etc.). In some embodiments the medicine bottle label may include geometric variations. For example, the label may include nubs indicating that the bottle is medication for a specific user. In some embodiments, the label may include a pattern of shapes or colors for assisting visually impaired individuals. For example, a zebra pattern may be placed on one label and a checkered pattern may be placed on another bottle.

It will be apparent that in all variations previously presented herewith a medicine bottle may include a primary label on the bottle and a secondary label on a coded sealing device. Further, it will be apparent that the shape of the label on the coded sealing device may vary amongst users. For example, a round label may be for a girl and a square label may be for a boy. Any color within the visible spectrum may be used for at least one of a coded sealing device and label. Any pattern may be used for at least one of a coded sealing device and label. It will be apparent that any combination of colors and shapes may be used for the label as well as the coded sealing device. Further, although shown as being substantially circular a coded sealing device may be any shape deemed suitable and a label may be located on any surface of a coded sealing device deemed suitable.

It is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Although the present invention has been described and illustrated in the foregoing exemplary embodiments, it is understood that the present disclosure has been made only by way of example, and that numerous changes in the details of implementation of the invention may be made without departing from the spirit and scope of the invention, which is limited only by the claims which follow.

What is claimed is:

1-45. (canceled)

46. A method comprising:
receiving, on a processor, a fulfillment request to fulfill a prescription at a pharmacy;
accessing, on the processor, patient data of a patient associated with the prescription based on receipt of the fulfillment request;
selecting, on the processor, a medication sealing device among a plurality of different types of medication sealing devices for a medication container based on the patient data, the medication sealing device having a substantially solid structure that includes a sidewall including a sidewall surface, a top surface, and a container receiving section used to seal a medication container;
labeling the medication sealing device based on the patient data;
filling a medication container with prescription drug based on receipt of the fulfillment request; and
securing the medication sealing device with labeling to the medication container containing the prescription drug.

47. The method of claim 46, wherein labeling the medication sealing device includes:
printing a label based on the patient data; and
affixing the label to the medication sealing device.

48. The method of claim 46, wherein labeling the medication sealing device further includes:
selecting a label color of the label from among a plurality of different colors, wherein the label is a colored label with the label color.

49. The method of claim 47, wherein the label is affixed to a top surface of the medication sealing device.

50. The method of claim 47, wherein the label is affixed to a sidewall of the medication sealing device.

51. The method of claim 47, wherein the label is affixed to a top surface and a sidewall of the medication sealing device.

52. The method of claim 46, wherein labeling the medication sealing device includes:
printing directly on the medication sealing device.

53. The method of claim 52, wherein printing occurs on a sidewall of the medication sealing device.

54. The method of claim 52, wherein printing occurs on a top surface of the medication sealing device.

55. The method of claim 46, wherein labeling the medication sealing device includes:
labeling the medication sealing device based on the patient data to include medication information associated with the prescription.

56. The method of claim 46, wherein labeling the medication sealing device includes:
labeling the medication sealing device based on the patient data to include individual characteristic information associated with the patient.

57. The method of claim 46, wherein the medication container is a medication bottle and the medication sealing device is a lid.

58. The method of claim 46, wherein the medication sealing device is of a first color type and a different medication sealing device of the plurality of different types of medication sealing devices is of a different color type.

59. The method of claim 47, wherein the medication sealing device includes a triangular shaped extension creating an additional flat surface and a different medication sealing device of the plurality of different types of medication sealing devices does not include the triangular shaped extension,
wherein the label is affixed to the additional flat surface of the medication sealing device.

60. The method of claim 46, further comprising:
receiving a color type selection specified by the patient; and
storing a patient-specified color type specified by the patient as at least part of the patient data based on receipt of the color type selection,
wherein selection of the medication sealing device among the plurality of different types of medication sealing devices for the medication container is based on the patient-specified color type.

61. The method of claim 46, further comprising:
receiving a color type selection specified by a doctor on behalf of the patient; and
storing a doctor-specified color type specified by the doctor as at least part of the patient data based on receipt of the color type selection,
wherein selection of the medication sealing device among the plurality of different types of medication sealing devices for the medication container is based on the doctor-specified color type.

62. The method of claim 46, further comprising:
assigning a color type selection on behalf of the patient based on the patient data as a pharmacy-specified color type,
wherein selection of the medication sealing device among the plurality of different types of medication sealing devices for the medication container is based on assignment of the color type selection.

63. The method of claim 62, wherein assignment of the color type selection is based on a sex of the patient, a gender of the patient, a family relationship of the patient with other family members in a family of the patient, or combinations thereof.

64. The method of claim 46, further comprising:
selecting the medication container from among a plurality of different types of medication containers based on the patient data, each of the different types of medication containers having a different geometry.

65. A non-transitory machine-readable medium comprising instructions, which when executed by one or more processors, cause the one or more processors to perform the following operations:
receive a fulfillment request to fulfill a prescription at a pharmacy;
access patient data of a patient associated with the prescription based on receipt of the fulfillment request;
select a medication sealing device among a plurality of different types of medication sealing devices for a medication container based on the patient data, the medication sealing device having a substantially solid structure that includes a sidewall including a sidewall surface, a top surface, and a container receiving section used to seal a medication container;
label the medication sealing device based on the patient data;
fill a medication container with prescription drug based on receipt of the fulfillment request; and
secure the medication sealing device with labeling to the medication container containing the prescription drug.
